(19) United States
(12) Patent Application Publication
(10) Pub. No.: US 2026/0285325 A1
(43) Pub. Date: Sep. 24, 2026

(54) SYSTEM AND METHOD OF PREDICTING DRIVER BEHAVIOR

(71) Applicant: Eye-Net Mobile Ltd., Ness Ziona (IL)

(72) Inventors: Dror ELBAZ, Rishon Lezion (IL); Tal LAVI, Modi’in (IL)

(73) Assignee: Eye-Net Mobile Ltd., Ness Ziona (IL)

(21) Appl. No.: 19/168,278

(22) PCT Filed: Mar. 26, 2024
(86) PCT No.: PCT/IL2024/050308

§ 371 Date: Sep. 23, 2025

Related U.S. Application Data
(60) Provisional application No. 63/454,685, filed on Mar. 26, 2023.

(51) Int. Cl. B60W 40/09; B60W 30/095; B60W 50/00; B60W 50/14

(52) U.S. Cl. CPC B60W 40/09; B60W 30/0956; B60W 50/0097; B60W 50/14; B60W 2050/0029; B60W 2050/146; B60W 2554/4041; B60W 2554/4044; B60W 2554/4045; B60W 2556/50

(57) ABSTRACT

EYEN-P-003-PCT The present invention relates generally to the technological field of autonomous driving and advanced driver assistance. More specifically, the present invention relates to preventing occurrence of collisions and dangerous driving situations. The invention may be directed to a method of predicting driver behavior by at least one computing device. The method may include receiving a plurality of motion data elements, characterizing motion of at least one vehicle in at least one specific driving situation; based on the plurality of motion data elements, constructing a behavioral model representing expected driver behavior in the at least one specific driving situation; and inferring the behavioral model on at least one incoming motion data element, to predict expected driver behavior in the specific driving situation.

### CROSS REFERENCE TO RELATED APPLICATIONS

This application claims the benefit of priority of U.S. Provisional Patent Application No. 63/454,685, filed Mar. 26, 2023, the contents of which are all incorporated herein by reference in their entirety.

### FIELD OF THE INVENTION

The present invention relates generally to the technological field of autonomous driving and advanced driver assistance. More specifically, the present invention relates to preventing occurrence of collisions and dangerous driving situations.

### BACKGROUND OF THE INVENTION

As known in the art, advanced driver-assistance systems (ADAS) represent a group of electronic and computer-implemented technologies that assist drivers in various driving aspects. ADAS use a plurality of input modules, such as sensors and cameras, to detect nearby obstacles or driver errors, and respond accordingly. Most technologies used for driver-assistance purposes are often applied in autonomous driving systems and vice versa.

The main purpose of using ADAS is to automate, adapt, and enhance different aspects of vehicle technology in order to increase driving safety, for example, by alerting a driver about various vehicle component errors and malfunctions via a user interface or by providing respective controlling signals (steering, accelerating, braking etc.) to control driving. Safety features of such systems may also assist in performing safeguard functions, automate lighting control, provide adaptive cruise control, incorporate satellite navigation and traffic warnings, alert drivers about possible obstacles, assist in lane departure and lane centering etc. Thereby, ADAS help to avoid crashes and collisions.

Most road collisions and crashes are known to occur due to human error which is often caused by inappropriate driving behavior (overspeeding, disobeying traffic rules, (e.g., taking wrong turns), aggressive, reckless and drunk driving etc.). Although there are a lot of technologies directed to negation of human driving errors known nowadays, this aspect still remains an active research topic.

### SUMMARY OF THE INVENTION

Accordingly, there is a need for a system and method of predicting driver behavior which would provide an improvement of the technological field of advanced driver assistance and autonomous driving by reducing risk of collisions occurring due to human error.

In the general aspect, the invention may be directed to a method of predicting driver behavior by at least one computing device. The method may include receiving a plurality of motion data elements, characterizing motion of at least one vehicle in at least one specific driving situation; based on the plurality of motion data elements, constructing a behavioral model representing expected driver behavior in the at least one specific driving situation; and inferring the behavioral model on at least one incoming motion data element, to predict expected driver behavior in the specific driving situation.

In another general aspect, the invention may be directed to a method of predicting motion of a vehicle by at least one computing device, the method may include receiving a plurality of geolocation data elements, representing geolocation of at least one vehicle, wherein each geolocation data element is attributed with a respective global timestamp and reception timestamp, representing time of determination of a respective geolocation and time of reception of the respective geolocation data element correspondingly; calculating a plurality of extrapolated geolocation data elements, based on (i) respective geolocations; (ii) the respective global timestamps, and (iii) respective reception timestamps of respective geolocation data elements of the plurality of geolocation data elements; calculating at least one incoming motion data element, representing velocity and direction of motion between the plurality of extrapolated geolocations; and inferring a pretrained machine-learning (ML)-based model on the at least one incoming motion data element, to predict an outcoming motion data element, representing an expected motion of the at least one vehicle.

In yet another general aspect, the invention may be directed to a system for predicting driver behavior, the system including a non-transitory memory device, wherein modules of instruction code are stored, and at least one processor associated with the memory device, and configured to execute the modules of instruction code, whereupon execution of said modules of instruction code, the at least one processor is configured to: receive a plurality of motion data elements, characterizing motion of at least one vehicle in at least one specific driving situation; based on the plurality of motion data elements, construct a behavioral model representing expected driver behavior in the at least one specific driving situation; infer the behavioral model on at least one incoming motion data element, to predict expected driver behavior in the specific driving situation.

In some embodiments, the at least one specific driving situation may be predefined by a plurality of motion scenarios. The expected driver behavior may be predefined by a plurality of expected driver decisions each corresponding to following a particular motion scenario of the plurality of motion scenarios. Inferring the behavioral model may include inferring the behavioral model on the at least one incoming motion data element, to predict occurrence of a particular driver decision of the plurality of expected driver decisions.

In some embodiments, each of the plurality of motion scenarios may be represented as a sequence of respective motion data elements of the plurality of motion data elements.

In some embodiments, the behavioral model may be a machine-learning (ML)-based model; and constructing the behavioral model may include analyzing the plurality of motion data elements, to determine sequences of motion data elements of the plurality of motion data elements, representing the plurality of motion scenarios; forming a plurality of decision data elements, respectively representing plurality of expected driver decisions each corresponding to following a particular motion scenario of the plurality of motion scenarios; and training the behavioral model based on the plurality of decision data elements to: (a) receive the incoming motion data element; (b) calculate probabilities of occurrence of particular driver decisions of the plurality of expected driver decisions, based on the incoming motion data element, and (c) predict occurrence of the particular driver decision, based on said probabilities.

In some embodiments, receiving a plurality of motion data elements, may include receiving a plurality of motion data elements, characterizing motion of a plurality of vehicles in the at least one specific driving situation; and the method may further include analyzing the plurality of decision data elements to obtain a baseline profile data element, representing a baseline distribution of the plurality of expected driver decisions with respect to the at least one particular motion scenario of the plurality of motion scenarios; and analyzing at least one incoming motion data element of the at least one vehicle, in relation to the baseline distribution, to obtain a vehicle-specific profile data element, representing deviation of one or more driver decisions of the respective vehicle, with respect to following the at least one particular motion scenario.

In some embodiments, the method may further include receiving the vehicle-specific profile data element of the at least one vehicle; and inferring the behavioral model may further include inferring the behavioral model on (a) the at least one incoming motion data element, and (b) the vehicle-specific profile data element to predict occurrence of the particular driver decision of the plurality of expected driver decisions.

In some embodiments, the expected driver decision may be represented by at least one outcoming motion data element, characterizing an expected motion of at least one vehicle in at least one specific driving situation.

In some embodiments, said constructing of the behavioral model may be performed by at least one server computing device, and said inferring of the behavioral model may be performed by at least one client computing device, communicatively connected to the at least one server computing device.

In some embodiments, the at least one client computing device is associated with a first vehicle, and the method may further include determining, by the at least one client computing device, the geolocation of the first vehicle; obtaining, by the at least one client computing device from the at least one server computing device, a segment of the behavioral model, representing a geographic region that surrounds the geolocation of the first vehicle; obtaining, by the at least one client computing device from the at least one server computing device, at least one second motion data element corresponding to geolocation of a second vehicle within the geographic region; and inferring, by the at least one client computing device, the segment of the behavioral model on the at least one second motion data element, to predict occurrence of the particular driver decision of the second vehicle.

In some embodiments, the particular driver decision of the second vehicle may be represented by at least one second outcoming motion data element, characterizing an expected motion of the second vehicle in the at least one specific driving situation within the geographic region; and the method may further include calculating an expected motion trajectory of the second vehicle, based on the at least one second outcoming motion data element of the second vehicle.

In some embodiments, the expected motion trajectory may be calculated as a Bezier curve.

In some embodiments, the method may further include receiving, by the at least one client computing device, the at least one first incoming motion data element, characterizing current motion of the first vehicle; inferring, by the at least one client computing device, the segment of the behavioral model on the at least one first incoming motion data element, to predict occurrence of the particular driver decision of the first vehicle, represented by at least one first outcoming motion data element, characterizing an expected motion of the first vehicle in the at least one specific driving situation within the geographic region; calculating, by the at least one client computing device, an expected motion trajectory of the first vehicle, based on the at least one first outcoming motion data element; calculating, by the at least one client computing device, a risk of collision between the first vehicle and second vehicle, based on the expected motion trajectories of the first vehicle and the second vehicle; and when the calculated risk of collision surpasses a predefined threshold, then providing a collision warning via a user interface of the client computing device.

In some embodiments, calculating the expected motion trajectory may include iteratively inferring, by the at least one client computing device, the segment of the behavioral model on at least one respective outcoming motion data element calculated on a preceding iteration, to predict a sequence of respective driver decisions of the respective vehicle, represented as a sequence of outcoming motion data elements, wherein outcoming motion data element of each iteration represents motion of the respective vehicle at a future point in time that precedes that of a subsequent iteration.

In some embodiments, each of the sequence of respective driver decisions is associated with a probability of occurrence of each of the respective driver decisions; and calculating the expected motion trajectory may further include calculating a diminishing probability path data element, representing probability of following the expected motion trajectory, based on (i) the sequence of outcoming motion data elements, and (ii) the respective probabilities of occurrence of the respective driver decisions.

In some embodiments, each of the plurality of motion data elements may represent at least one of (a) geolocation of the at least one vehicle; (b) velocity of the at least one vehicle; (c) acceleration of the at least one vehicle; (d) motion direction of the at least one vehicle.

In some embodiments, the method may further include receiving a plurality of geolocation data elements, representing respective plurality of geolocations of the at least one vehicle; and based on the plurality of geolocation data elements, calculating respective motion data elements of the plurality of motion data elements as motion vectors characterizing motion of the at least one vehicle between the plurality of geolocations.

In some embodiments, the method may further include receiving a plurality of geolocation data elements, representing respective plurality of geolocations of the at least one vehicle, wherein the plurality of geolocation data elements is attributed with respective global timestamps and reception timestamps, representing time of determination of a respective geolocation and time of reception of the respective geolocation data element correspondingly; calculating extrapolated geolocations of the at least one vehicle, based on (i) the respective plurality of geolocations; (ii) respective global timestamps and (iii) respective reception timestamps of the plurality geolocation data elements; and calculating the at least one incoming motion data element as a motion vector, further based on the extrapolated geolocations.

In some embodiments, the method may further include receiving a plurality of geolocation data elements, representing geolocation of a plurality of vehicles; based on the plurality of geolocation data elements, calculating a plurality of motion data elements, representing velocity and direction of motion of respective vehicles of the plurality of vehicles between respective geolocations; analyzing the plurality of motion data elements, to determine sequences of motion data elements of the plurality of motion data elements, representing a plurality of motion scenarios in at least one specific driving situation; forming a plurality of decision data elements, respectively representing plurality of expected driver decisions each corresponding to following a particular motion scenario of the plurality of motion scenarios; and training the ML-based model based on the plurality of decision data elements to: (a) receive the incoming motion data element; (b) calculate probabilities of occurrence of particular driver decisions of the plurality of expected driver decisions, (c) predict occurrence of the particular driver decision, based on said probabilities, (d) calculate the outcoming motion data element, characterizing an expected motion of the at least one vehicle in the at least one specific driving situation, based on the predicted occurrence of the particular driver decision.

In some embodiments, the at least one specific driving situation may be predefined by a plurality of motion scenarios; the expected driver behavior may predefined by a plurality of expected driver decisions each corresponding to following a particular motion scenario of the plurality of motion scenarios; and the at least one processor may be configured to infer the behavioral model further by inferring the behavioral model on the at least one incoming motion data element, to predict occurrence of a particular driver decision of the plurality of expected driver decisions.

In some embodiments, the behavioral model may be a machine-learning (ML)-based model; and the at least one processor may be configured to construct the behavioral model by: analyzing the plurality of motion data elements, to determine sequences of motion data elements of the plurality of motion data elements, representing the plurality of motion scenarios; forming a plurality of decision data elements, respectively representing plurality of expected driver decisions each corresponding to following a particular motion scenario of the plurality of motion scenarios; and training the behavioral model based on the plurality of decision data elements to: (a) receive the incoming motion data element; (b) calculate probabilities of occurrence of particular driver decisions of the plurality of expected driver decisions, based on the incoming motion data element, and (c) predict occurrence of the particular driver decision, based on said probabilities.

In some embodiments, the plurality of motion data elements may characterize motion of a plurality of vehicles in the at least one specific driving situation; and the at least one processor may be further configured to: analyze the plurality of decision data elements to obtain a baseline profile data element, representing a baseline distribution of the plurality of expected driver decisions with respect to the at least one particular motion scenario of the plurality of motion scenarios; and analyze at least one incoming motion data element of the at least one vehicle, in relation to the baseline distribution, to obtain a vehicle-specific profile data element, representing deviation of one or more driver decisions of the respective vehicle, with respect to following the at least one particular motion scenario.

In some embodiments, the at least one processor may be further configured to: receive the vehicle-specific profile data element of the at least one vehicle; and infer the behavioral model further by inferring the behavioral model on (a) the at least one incoming motion data element, and (b) the vehicle-specific profile data element, to predict occurrence of the particular driver decision of the plurality of expected driver decisions.

In some embodiments, said at least one processor may comprise: at least one first processor associated with at least one server computing device; and at least one second processor associated with at least one client computing device communicatively connected to said at least one server computing device; and wherein the at least one processor configured to construct the behavioral model may be the at least one first processor, and the at least one processor configured to infer the behavioral model may be the at least one second processor.

In some embodiments, the at least one client computing device may be associated with a first vehicle, and wherein the at least one second processor may be further configured to: determine the geolocation of the first vehicle; obtain, from the at least one server computing device, a segment of the behavioral model, representing a geographic region that surrounds the geolocation of the first vehicle; obtain, from the at least one server computing device, at least one second motion data element corresponding to a geolocation of a second vehicle within the geographic region; and infer the behavioral model by inferring the segment of the behavioral model on the at least one second motion data element, to predict occurrence of the particular driver decision of the second vehicle.

In some embodiments, the particular driver decision of the second vehicle may be represented by at least one second outcoming motion data element, characterizing an expected motion of the second vehicle in the at least one specific driving situation within the geographic region; and the at least one second processor may be further configured to calculate an expected motion trajectory of the second vehicle, based on the at least one second outcoming motion data element of the second vehicle.

In some embodiments, the at least one second processor may be further configured to: obtain the at least one first incoming motion data element, characterizing current motion of the first vehicle; infer the segment of the behavioral model on the at least one first incoming motion data element, to predict occurrence of the particular driver decision of the first vehicle, represented by at least one first outcoming motion data element, characterizing an expected motion of the first vehicle in the at least one specific driving situation within the geographic region; calculate an expected motion trajectory of the first vehicle, based on the at least one first outcoming motion data element; calculate a risk of collision between the first vehicle and the second vehicle, based on the expected motion trajectories of the first vehicle and the second vehicle; and when the calculated risk of collision surpasses a predefined threshold, then provide a collision warning via a user interface (UI) of the at least one client computing device.

In some embodiments, the at least one second processor may be configured to calculate the expected motion trajectory by: iteratively inferring the segment of the behavioral model on at least one respective outcoming motion data element calculated on a preceding iteration, to predict a sequence of respective driver decisions of the respective vehicle, represented as a sequence of outcoming motion data elements, wherein outcoming motion data element of each iteration represents motion of the respective vehicle at a future point in time that precedes that of a subsequent iteration.

In some embodiments, the sequence of respective driver decisions may be associated with a probability of occurrence of each of the respective driver decisions; and the at least one second processor may be configured to calculate the expected motion trajectory further by calculating a diminishing probability path data element, representing probability of following the expected motion trajectory, based on (i) the sequence of outcoming motion data elements, and (ii) the respective probabilities of occurrence of the respective driver decisions.

In some embodiments, the at least one second processor may be further configured to calculate the expected motion trajectory as a Bezier curve.

In some embodiments, the at least one processor may be further configured to: receive a plurality of geolocation data elements, representing respective plurality of geolocations of the at least one vehicle; based on the plurality of geolocation data elements, calculate respective motion data elements of the plurality of motion data elements as motion vectors characterizing motion of the at least one vehicle between the plurality of geolocations.

In some embodiments, the at least one processor may be further configured to: receive a plurality of geolocation data elements, representing respective plurality of geolocations of the at least one vehicle, wherein the plurality of geolocation data elements is attributed with respective global timestamps and reception timestamps, representing time of determination of a respective geolocation and time of reception of the respective geolocation data element correspondingly; calculate extrapolated geolocations of the at least one vehicle, based on (i) the respective plurality of geolocations; (ii) respective global timestamps and (iii) respective reception timestamps of the plurality geolocation data elements; and calculate the at least one incoming motion data element as a motion vector, further based on the extrapolated geolocations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for predicting driver behavior, according to some embodiments;

FIG. 2 is a schematic representation of a concept of the present invention with respect to providing collision warnings via UI, according to some embodiments;

FIGS. 3A and 3B are schematic representations of a concept of the present invention with respect to predicting driving decision of following the particular motion scenario;

FIG. 4A is a block diagram, depicting a client computing device of a system for predicting driver behavior, according to some embodiments;

FIG. 4B is a block diagram, depicting a client computing device of a system for predicting driver behavior, according to some alternative embodiments;

FIG. 4C is a block diagram, depicting a server computing device of a system for predicting driver behavior, according to some embodiments;

FIG. 5A is a flow diagram, depicting a method of predicting driver behavior, according to some embodiments;

FIG. 5B is a flow diagram, depicting a method of predicting motion of a vehicle, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, “choosing”, “selecting”, “omitting”, “training” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, concurrently, or iteratively and repeatedly.

In embodiments of the present invention, some steps of the claimed method may be performed using machine-learning (ML)-based models. ML-based models may be configured or “trained” for a specific task, e.g., classification or regression.

In some embodiments, ML-based models may be artificial neural networks (ANN).

A neural network (NN) or an artificial neural network (ANN), e.g., a neural network implementing a machine learning (ML) or artificial intelligence (AI) function, may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g., CPUs or graphics processing units (GPUs), or a dedicated hardware device may perform the relevant calculations.

It should be obvious for the one ordinarily skilled in the art that various ML-based models can be implemented without departing from the essence of the present invention. It should also be understood, that in some embodiments ML-based model may be a single ML-based model or a set (ensemble) of ML-based models realizing as a whole the same function as a single one. Hence, in view of the scope of the present invention, the abovementioned variants should be considered equivalent.

In the context of the present description, the term “driving situation” shall be considered in the broadest possible meaning. It may refer to any specific situation that may occur during the process of driving a vehicle and that may require a driver to make a decision on how to act therein. For example, driving situation may include selecting a particular path in the intersection (e.g., whether to turn left or right, or continue going straight), passing the specific segment of the road, overtaking another vehicle, parking etc. It shall also be understood that, depending on the embodiments of the present invention, “driving situation” may be referred to specific geolocation (e.g., specific intersection, segment of the road etc.) or may be general and combine all similar cases irrespective to their geolocation.

Accordingly, the general term “driver behavior” or more specific term “driver decision” shall be understood as a way the respective driver behaves or a decision the respective driver has to make when getting into the respective driving situation. For example, driver decision or behavior may include deciding whether to turn or continue going straight, whether to accelerate or decelerate when passing the specific segment of the road, whether to overtake another vehicle when passing the specific segment of the road and or at specific speed or not etc. However, the terms “driver behavior” and “driver decision” shall not be confused with behavior or decisions with respect to performing any actions not related to the process of controlling the vehicle while driving it.

As can be seen, in the present description, it is suggested to gather motion data of vehicles (e.g., motion data elements, which may combine geolocation, velocity, acceleration, motion direction etc.) in at least one specific driving situation (e.g., intersection) and then construct a behavioral model, which represents driver behavior (e.g., driver decisions, that is, specific driving actions) in this situation. The situation may be predefined by a plurality of motion scenarios (e.g., (a) turning or (b) going straight).

Each of the plurality of motion scenarios may be represented as a sequence of respective motion data elements of the plurality of motion data elements. The “sequence of motion data elements” in this context means the ordered plurality of motion data elements each corresponding to respective phase of the motion of the vehicle within the respective scenario.

E.g., the scenario of “turning right” may be represented by n number of motion data elements, starting with a motion data element indicating decreasing speed when approaching the intersection, then several motion data elements representing the action of turning itself (e.g., changing motion direction), and then finishing with motion data element indicating increasing speed with no further changes in motion direction. The scenario of “going straight”, in turn, may be represented by m number of motion data elements, each of which may indicate gradual increase of speed with no changes in motion direction.

Hence, as can be seen from the provided example, each sequence of motion data elements may clearly represent a “behavioral signature” of the respective scenario, and, consequently, a “signature” of each “expected driver decision”. E.g., when, in certain proximity to the intersection, received motion data element (or sequence of motion data elements) indicates decreasing speed, with certain probability, it may be predicted (e.g., based on the known-in-the-art mathematical methods) that the expected following driver decision will be to take a turn rather than to continue going straight.

Thus, by applying such a behavioral model, as explained in detail in the present description, the reliable prediction of driver behavior may be provided, which may be further used as a valuable tool of advanced driver assistance systems and autonomous driving systems for providing warnings or control signals in cases of dangerous road situations, inappropriate driver behavior etc., thereby reducing risk of collisions occurring due to human error.

Furthermore, the present invention may have various embodiments with respect to constructing (training) the behavioral model. In particular, in some embodiments, the behavioral model may be trained based on motion data elements of each vehicle separately. In such embodiments, each vehicle and, hence, each particular driver, may have its own vehicle-specific profile, indicating the way each particular vehicle (driver) behaves in a specific driving situation. Consequently, the specificity of driving peculiarities of each particular driver may be evaluated, thereby increasing the efficiency of collision prevention.

In other embodiments, the behavioral model may be trained based on motion data elements of a plurality of vehicles. In such embodiments, a baseline profile may be calculated, as further described in detail herein.

Furthermore, in yet another embodiments, the abovementioned approaches may be used in combination. In particular, the method may include calculation of a baseline profile and then calculation of a vehicle-specific profile with respect to the baseline one. In such cases, the behavior of each particular driver may be evaluated with respect to the baseline behavior, thereby drivers having inappropriate driving behavior may be identified, and other drivers which are located close to such potentially dangerous ones may be alerted correspondingly.

It shall be understood that the term “behavioral model” refers herein to a mathematical model (in some embodiments, machine-learning-based model) of a plurality of driving situations, each represented by a plurality of motion scenarios, each in turn represented by a plurality of motion data elements in turn represented by motion parameters, such as (a) a geolocation of the at least one vehicle; (b) a velocity of the at least one vehicle; (c) an acceleration of the at least one vehicle; (d) a motion direction of the at least one vehicle etc. In some respective embodiments, the behavioral model may be, e.g., geolocation-oriented, and accordingly, may be segmented by a geographic region that surrounds the desired geolocation. It shall be appreciated by the person skilled in the art that “behavioral model”, as described herein, may be constructed (or, in case of machine learning-trained) and further applied (inferred) using mathematical (e.g., machine-learning-based) methods known in the art. The present invention shall not be considered limited regarding any specific methods of constructing such behavioral models.

It shall further be understood that various types of calculations described in the present application (such as, e.g., calculation of probabilities of occurrence of particular driver decisions of the plurality of expected driver decisions, calculation of an expected motion trajectory of a vehicle, calculation of a risk of collision between vehicles, calculation of extrapolated geolocations etc.), each of the calculations being based on a respective input indicated in the present disclosure, may, for example, be performed using known mathematical methods and techniques of a general knowledge in the art, which shall be apparent for the person skilled in the art.

Yet another important aspect of the present invention that contributes into the abovementioned technical improvement lies in the purpose and necessity of relying on prediction of driver behavior and driver decisions. In particular, for the matter of proof by contradiction, if consider hypothetical system and method which provide no prediction of driver behavior and driver decisions and rely exclusively on the current motion data received from the vehicles (e.g., their geolocation, speed, motion direction etc.), such system and method would not be effective in preventing collisions. Obviously, driving is a dynamic process and each occurring situation may change very fast, especially when driving speed is relatively high. Furthermore, if such a system or method requires receiving information from server via network, network latency shall also be taken into account. On the other hand, the driver needs some time to react to the alert. As can be seen, time is a crucial aspect of negating the risk of collision.

The present invention addresses this issue by applying behavioral model to predict behavior and decisions of one driver and alert another driver (or provide respective controlling signals) beforehand, thereby giving him time to react. It additionally contributes to improvement of the technological field of advanced driver assistance and autonomous driving by mitigating network latency issues.

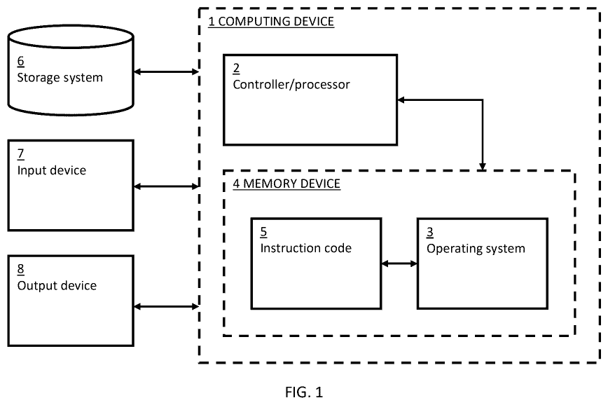

Reference is now made to FIG. 1, which is a block diagram depicting a computing device, which may be included within an embodiment of the system for predicting driver behavior, according to some embodiments.

Computing device 1 may include a processor or controller 2 that may be, for example, a central processing unit (CPU) processor, a chip or any suitable computing or computational device, an operating system 3, a memory device 4, instruction code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to instruction code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory device 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory device 4 may be or may include a plurality of possibly different memory units. Memory device 4 may be a computer or processor non-transitory readable medium, or a computer non-transitory storage medium, e.g., a RAM. In one embodiment, a non-transitory storage medium such as memory device 4, a hard disk drive, another storage device, etc. may store instructions or code which when executed by a processor may cause the processor to carry out methods as described herein.

Instruction code 5 may be any executable code, e.g., an application, a program, a process, task, or script. Instruction code 5 may be executed by processor or controller 2 possibly under control of operating system 3. For example, instruction code 5 may be a standalone application or an API module that may be configured to calculate prediction of a driver behavior or an occurrence of a particular driver decision, as further described herein. Although, for the sake of clarity, a single item of instruction code 5 is shown in FIG. 1, a system according to some embodiments of the invention may include a plurality of executable code segments or modules similar to instruction code 5 that may be loaded into memory device 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Various types of input and output data may be stored in storage system 6 and may be loaded from storage system 6 into memory device 4 where it may be processed by processor or controller 2. In some embodiments, some of the components shown in FIG. 1 may be omitted. For example, memory device 4 may be a non-volatile memory having the storage capacity of storage system 6. Accordingly, although shown as a separate component, storage system 6 may be embedded or included in memory device 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

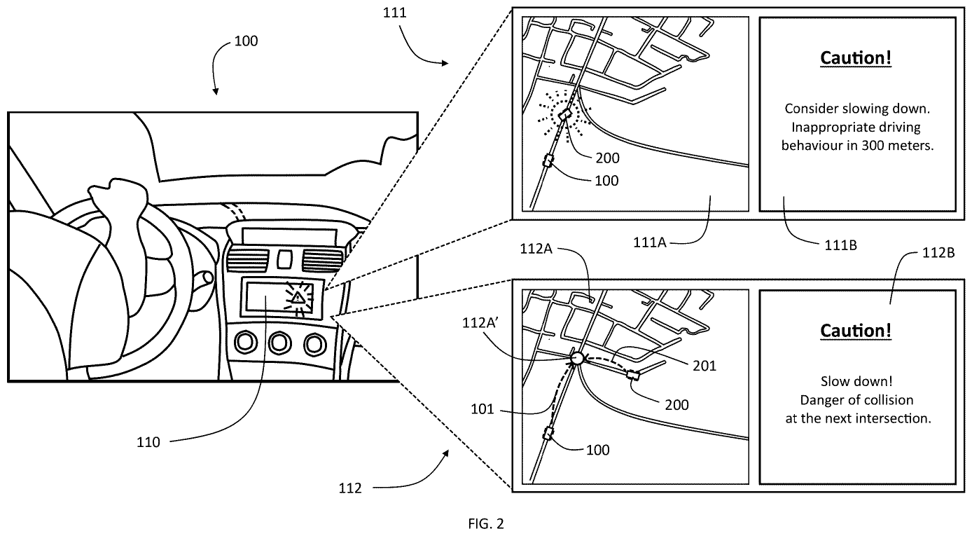

Reference is now made to FIG. 2, which depicts a schematic representation of a concept of the present invention with respect to providing collision warnings via UI, according to some embodiments.

As can be seen, according to the concept of the present invention, driver of a specific vehicle (e.g., first vehicle 100), may be provided with collision warning (e.g., warnings 111 and 112) via user interface (UI) 110 of a client computing device 30 associated with (e.g., installed in) the vehicle.

Collision warnings 111 and 112 may be provided as a result of detected and predicted behavior of the driver of another vehicle (e.g., second vehicle 200) which is located in the geographic region that surrounds the geolocation of the first vehicle.

E.g., in case of warning 111, the system may calculate baseline profile of driver behavior in the segment of the road which both first vehicle 100 and second vehicle 200 are currently driving through. Then the system may calculate the vehicle-specific profile of each vehicle, in relation to the baseline profile, representing deviation of driver decisions of the respective vehicle, with respect to following the at least one particular motion scenario (e.g., scenario of passing said segment of the road, shown on map 111A provided via UI 110). After that, the system may detect that the deviation of the driver decision, according to vehicle-specific profile of second vehicle 200, substantially deviates from that of the baseline profile (e.g., the driver of second vehicle 200 suddenly stopped his car and began turning around). Hence, the driver of first vehicle 100, on his way to the geolocation where said inappropriate driver behavior was detected, may be informed in advance and advised to slow down (e.g., as indicated in message 111B provided via UI 110). The driver of first vehicle 100 may optionally be informed about the distance to the vehicle which is indicated as having inappropriate behavior.

However, the scope of the present invention is not limited only to detection of inappropriate behavior. In another example, in case of warning 112, the system may use prediction of future driver behavior and driver decisions, based on the historical data (plurality of motion data elements) received and accumulated from the plurality of vehicles that passed the same segment of the road or same intersection (e.g., intersection 112A′, shown on map 112A provided via UI 110) that first and second vehicles 100 and 200 are currently approaching from different sides. So, for example, according to such predictions the system may detect that both drivers are not going to slow down their vehicles before crossing intersection 112A′. Furthermore, the system may be configured to calculate expected motion trajectories 101 and 201 of respective vehicles 100 and 200 based on respective pluralities of motion data elements representing respective sequences of expected driver decisions. Based on the expected motion trajectories 101 and 201 of respective vehicles 100 and 200, the system may be configured to calculate a risk of collision between vehicles 100 and 200. Hence, warning 112, including message 112B provided via UI 110, may be provided when the calculated risk of collision surpasses the predefined threshold.

It should be understood that said motion data elements may include data about geolocation, velocity, acceleration and motion direction of respective vehicle, hence, in the context of the present description, the term “trajectory” refers not only to a data element indicating a direction or path of motion, but to element having this “path” augmented with velocity, and/or acceleration, and/or exact geolocation. Furthermore, the expected motion trajectory data element may be augmented with diminishing probability path, representing probability of following the expected motion trajectory in its different segments. Accordingly, the system may be configured to calculate the risk of collision between vehicles 100 and 200, e.g., by calculating a probability of trajectories 101 and 201 to intersect (e.g., at the same point in time).

It should also be understood that trajectories 101 and 201 are shown in FIG. 2 schematically, in order to support the understanding of how the warning 112 is formed, rather than to provide examples of the trajectories themselves.

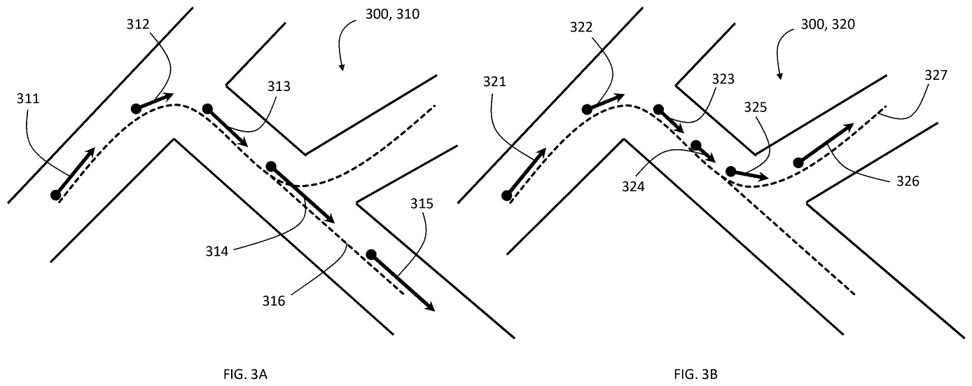

Reference is now made to FIGS. 3A and 3B, schematically representing a concept of the present invention with respect to predicting driving decision of following the particular motion scenario.

As it is indicated above, in some embodiments, specific driving situation (e.g., driving situation 300) may be predefined by a plurality of motion scenarios (e.g., motion scenario 310 shown in FIG. 3A and motion scenario 320 shown in FIG. 3B). Accordingly, in some embodiments, the expected driver behavior may be predefined by a plurality of expected driver decisions each corresponding to following a particular motion scenario of the plurality of motion scenarios (e.g., motion scenarios 310 and 320).

FIGS. 3A and 3B represent examples of two motion scenarios 310 and 320 that may occur in a specific driving situation (e.g., driving situation 300). As can be seen, situation 300 represents a case of two successive turns. According to motion scenario 310, respective driver takes first turn, but decides not to take the second one and to continue going straight. According to motion scenario 320, the respective driver decides to take both first and second turns.

In some embodiments, each of motion scenarios 310 and 320 may be represented as a sequence of respective motion data elements 311, 312, 313, 314, 315 and 321, 322, 323, 324, 325, 326 correspondingly. Each motion data element 311-315 and 321-326 is shown in figures as a velocity vector, representing a geolocation, velocity (e.g., represented as a length of the respective vector), and motion direction (e.g., represented as an orientation of the respective vector) of the respective vehicle.

As can be seen, motion data elements 311, 312 are equal to respective motion data elements 321, 322, hence, they do not represent any difference between motion scenarios 310 and 320 at this stage. However, beginning with motion data elements 313 and 323, the difference can be clearly seen. Since, according to motion scenario 310, driver decides not to take the second turn and to continue going straight, he is not slowing down his vehicle before the second turn. Accordingly, as shown in the figure, motion data elements 313, 314 and 315 indicate gradually increasing velocity of the vehicle (each following motion data element is longer than the preceding one).

Motion data elements 323 and 324, in turn, indicate the same motion direction as elements 313-315, however, with gradual decrease of vehicle velocity, which is a typical action before taking a turn. Elements 325 and 326 indicate changing motion direction and increasing velocity after the turn.

Furthermore, based on motion data elements 311-315 and 321-326 respective motion trajectories 316 and 327 may be calculated.

As can be seen in provided examples of motion scenarios 310 and 320, plurality of respective motion data elements may represent a strong basis for reliable prediction of expected driver behavior, in particular, of specific driver decision.

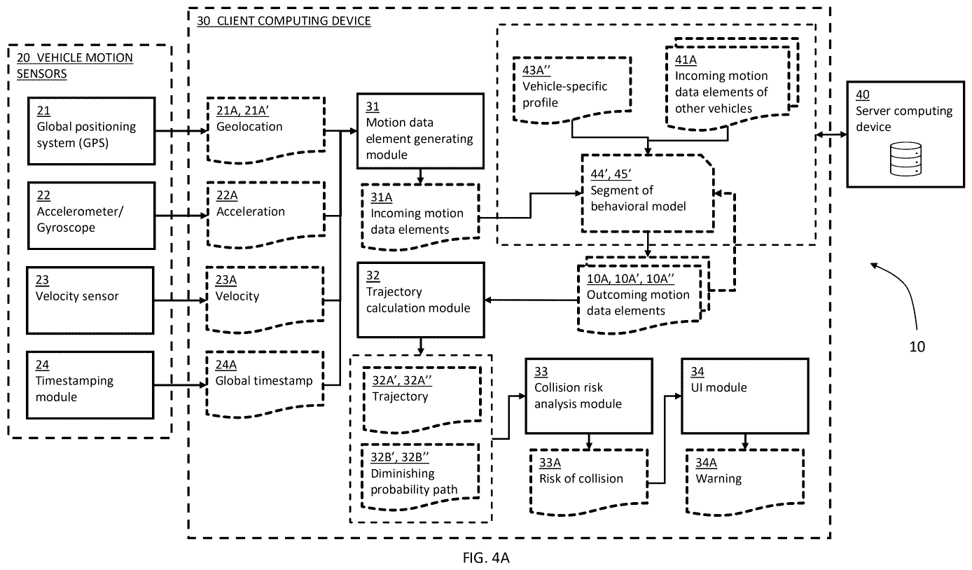

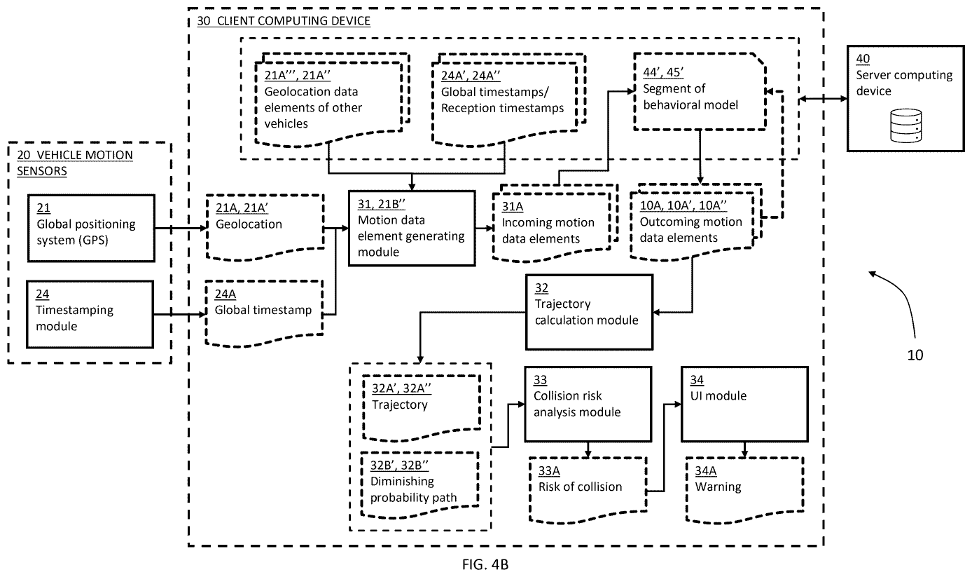

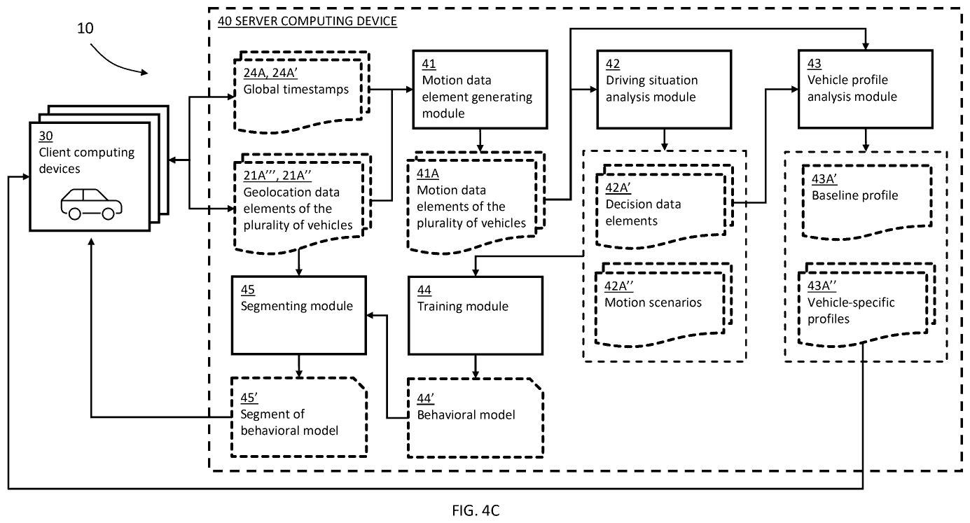

Reference is now made to FIGS. 4A, 4B and 4C which depict system 10 for predicting driver behavior, including at least one client computing device 30 communicatively connected to server computing device 40, according to some embodiments.

According to some embodiments of the invention, system 10 may be implemented as a software module, a hardware module, or any combination thereof. For example, system 10 may be or may include a computing device such as element 1 of FIG. 1. Furthermore, system 10 may be adapted to execute one or more modules of instruction code (e.g., element 5 of FIG. 1) to request, receive, analyze, calculate and produce various data.

As further described in detail herein, system 10 may be adapted to execute one or more modules of instruction code (e.g., element 5 of FIG. 1) in order to perform steps of the claimed method.

As shown in FIGS. 4A, 4B and 4C arrows may represent flow of one or more data elements to and from system 10 and/or among modules or elements of system 10. Some arrows have been omitted in FIGS. 4A, 4B and 4C for the purpose of clarity.

As shown in FIG. 4A, client computing device 10 may be associated with first vehicle 100, e.g., may be installed inside first vehicle 100. Client computing device 10 may be communicatively connected to vehicle motion sensors 20, including global positioning system (GPS) 21, accelerometer (or gyroscope) 22, velocity sensor 23 and timestamping module 24.

In some embodiments, client computing device 10 may be configured to receive geolocation data element 21A′, representing respective geolocation 21A of first vehicle 100. Client computing device 10 may be further configured to receive acceleration value 22A from accelerometer 22. Client computing device 10 may be further configured to receive velocity value 23A from velocity sensor 23. Client computing device 10 may be further configured to receive global timestamp 24A from timestamping module 24, indicating time of determination of respective parameters (e.g., geolocation 21A, acceleration value 22A, velocity value 23A) by sensors 20.

In some embodiments, client computing device 10 may include motion data element generating module 31. Motion data element generating module 31 may be configured to aggregate the data received from sensors 20 and form motion data elements (e.g., incoming motion data elements 31A), characterizing motion of first vehicle 100. Motion data elements 31A may represent geolocation, velocity, acceleration, motion direction of first vehicle 100, and be attributed with respective global timestamps 24A, representing time the respective measurements are made.

In some embodiments, motion data element generating module 31 may be configured to calculate the motion direction, based on a pair of successive geolocations 21A, e.g., as a direction of moving from the first geolocation 21A of the pair to the second one. In some alternative embodiments, motion data element generating module 31 may be configured to calculate the motion direction, based on acceleration value 22A from accelerometer 22 (e.g., if a 3-axis accelerometer sensor is used). It shall be understood that the abovementioned examples of motion direction calculation are non-exclusive and different methods may be used within the scope of the present invention.

Client computing device 30 may be further configured to obtain, from server computing device 40, segment 45′ of the behavioral model 44′, representing a geographic region that surrounds geolocation 21A of first vehicle 100. Client computing device 30 may be further configured to obtain, from server computing device 40, motion data elements (e.g., incoming motion data elements 41A of other vehicles) corresponding to geolocation of second vehicle 200 within the same geographic region.

Client computing device 30 may be further configured to infer segment 45′ of behavioral model 44′ on incoming motion data elements 31A of first vehicle 100, to predict expected driver behavior, e.g., to predict occurrence of particular driver decision 10A′ of first vehicle 100, represented by outcoming motion data elements (e.g., outcoming motion data elements 10A), characterizing an expected motion of first vehicle 100 in the at least one specific driving situation (e.g., driving situation 300, shown in FIGS. 3A, 3B) within the respective geographic region. Client computing device 30 may be further configured to infer segment 45′ of behavioral model 44′ on motion data elements (e.g., incoming motion data elements 41A of other vehicles) corresponding to geolocation of second vehicle 200, to predict occurrence of particular driver decision 10A″ of second vehicle 200, also represented by outcoming motion data elements (e.g., outcoming motion data elements 10A), and characterizing an expected motion of second vehicle 200 in the at least one specific driving situation (e.g., driving situation 300, shown in FIGS. 3A, 3B) within the respective geographic region.

Client computing device 30 may further include trajectory calculating module 32. Trajectory calculating module 32 may be further configured to receive outcoming motion data elements (e.g., outcoming motion data elements 10A) of first vehicle 100 and second vehicle 200. Trajectory calculating module 32 may be further configured to calculate expected motion trajectory 32A′ of first vehicle 100, based on the at least one outcoming motion data element (e.g., outcoming motion data elements 10A) of first vehicle 100. Trajectory calculating module 32 may be further configured to calculate expected motion trajectory 32A″ of second vehicle 200, based on the at least one outcoming motion data element (e.g., outcoming motion data elements 10A) of second vehicle 200.

In some embodiments, trajectory calculating module 32 may be further configured to calculate the expected motion trajectory (e.g., trajectory 32A′ or 32A″) as a Bezier curve.

In some embodiments, client computing device 30 may be further configured to calculate each of expected motion trajectories (e.g., trajectory 32A′ or 32A″) by iteratively inferring segment 45′ of behavioral model 44′ on respective outcoming motion data elements 10A calculated on a preceding iteration, to predict a sequence of respective driver decisions of the respective vehicle (e.g., decisions 10A′ or 10A″ of vehicles 100 or 200 accordingly), represented as a sequence of outcoming motion data elements 10A, wherein outcoming motion data element 10A of each iteration represents motion of respective vehicle 100 or 200 at a future point in time that precedes that of a subsequent iteration.

In some embodiments, client computing device 30 may be configured to calculate, by inferring segment 45′ of behavioral model 44′, probability of occurrence of respective driver decisions 10A′ and 10A″ of drivers of first vehicle 100 and second vehicle 200 respectively. Trajectory calculation module 32 may be further configured to calculate, with respect to first vehicle 100 and second vehicle 200, diminishing probability path data elements 32B′ and 32B″ respectively, representing probability of following expected motion trajectories 32A′ and 32A″ respectively, based on (i) the respective sequence of outcoming motion data elements 10A of the respective vehicle 100 and 200, and (ii) the respective probabilities of occurrence of the respective driver decisions 10A′ and 10A″.

In some embodiments, client computing device 30 may further include collision risk analysis module 33. Collision risk analysis module 33 may be configured to receive data representing expected motion trajectories 32A′ and 32A″ and, optionally, diminishing probability paths 23B′ and 32B″. Collision risk analysis module 33 may be further configured to calculate risk (e.g., probability) 33A of collision between first vehicle 100 and second vehicle 200, based on expected motion trajectories 32A′ and 32A″ and, optionally, based on diminishing probability paths 23B′ and 32B″ of first vehicle 100 and second vehicle 200 respectively.

Client computing device 30 may further include user interface (UI) module 34. UI module 34 may be configured to receive data about risk 33A of collision. UI module 34 may be further configured to provide collision warning 34A (e.g., same as warnings 111 and 112 shown in FIG. 2) to a respective driver (e.g., driver of first vehicle 100) via UI, when calculated risk of collision surpasses a predefined threshold.

It should be understood, that providing a collision warning 34A to a driver is provided only as a non-exclusive example of how predicted expected driver behavior or a particular driver decision (e.g., driver decision 10A′ or 10A″) may be further used in order to reduce risk of collisions, in particular collisions occurring due to human error.

E.g., in some alternative embodiments, first vehicle 100 may be a self-driving (autonomous) vehicle. Accordingly, in such cases, client computing device 30 may be further configured to apply respective control signals in order to omit collision (e.g., by slow down, accelerating, turn the respective vehicle), based on at least one of (i) expected driver decision (e.g., driver decision 10A″), (ii) outcoming motion data element 10A, (iii) motion trajectory 32A″, (iv) diminishing probability path 32B″ of other vehicle (e.g., second vehicle 200) in the geographic region that surrounds geolocation 21A of first vehicle 100.

Furthermore, in some alternative embodiments, client computing device 30 may be further configured to calculate a plurality of risks of collision (e.g., risk 33A of collision) for a plurality of motion scenarios (e.g., motion scenario 310 or 320). Client computing device 30 may be further configured to select and apply “driver” decision to follow the motion scenario (e.g., motion scenario 310 or 320), which is associated with the lowest risk of collision (e.g., risk 33A of collision).

Referring now to FIG. 4B, alternative embodiment of client computing device 30 is provided.

The provided embodiment is similar to the embodiment shown in FIG. 4A in most aspects, hence, only aspects that are different are described with reference to FIG. 4B.

As can be seen, in the provided embodiment, only geolocation 21A and global timestamps 24A are provided from vehicle motion sensors 20. Hence, in such embodiments, motion data element generating module 31 may be further configured to receive a plurality of geolocation data elements 21A′, representing respective plurality of geolocations 21A of first vehicle 100. Motion data element generating module 31 may be further configured to calculate respective motion data elements 31A as motion vectors (e.g., velocity vectors) characterizing motion (e.g., velocity and direction) of first vehicle 100 between the plurality of geolocations 21A based on the plurality of geolocation data elements 21A′.

In some embodiments, motion data element generating module 31 may be further configured to receive, from server computing device 40, a plurality of geolocation data elements 21A′″, representing respective plurality of geolocations 21A″ of other vehicles (e.g., of second vehicle 200), wherein the plurality of geolocation data elements 21A′″ is attributed with respective global timestamps 24A′ and reception timestamps 24A″, representing time of determination of a respective geolocation 21A″ and time of reception of the respective geolocation data element 21A′″ correspondingly. Motion data element generating module 31 may be further configured to calculate extrapolated geolocations 21B″ of the at least one vehicle (e.g., second vehicle 200), based on (i) the respective plurality of geolocations 21A″; (ii) respective global timestamps 24A′ and (iii) respective reception timestamps 24A″ of the plurality geolocation data elements 21A′″.

In some embodiments, motion data element generating module 31 may be further configured to calculate incoming motion data elements 31A as motion vectors (e.g., velocity vectors), further based on extrapolated geolocations 21B″.

As can be seen, the embodiment provided in FIG. 4B may have aspects which additionally contribute to the abovementioned technical effect, in particular, this embodiment may provide additional improvement into the negation of the risk of collision. Such an improvement may be provided by taking into account time of reception (reception timestamps 24A″) in combination with respective global timestamps 24A′, thereby negating the network latency (e.g., network that communicates server computing device 40 and client computing device 30) and correcting geolocation of respective vehicles (e.g., vehicle 200) accordingly.

Reference now is made to FIG. 4C, depicting server computing device 40 of system 10 for predicting driver behavior, according to some embodiments.

As can be seen, in some embodiments, server computing device 40 may include motion data element generating module 41. Motion data element generating module 41 may be similar or the same as motion data element generating module 31, which is described with reference to FIGS. 4A and 4B.

Motion data element generating module 41 may be configured to receive global timestamps 24A and 24A′ and plurality of geolocation data elements 21A′″, representing respective plurality of geolocations 21A″ of plurality of vehicles (e.g., vehicles 100 and 200) from respective client computing devices 30. Motion data element generating module 41 may be further configured to calculate motion data elements 41A of the plurality of vehicles (the same way as it is described with respect to motion data element generating module 31 with reference to FIGS. 4A and 4B). Motion data elements 41A may characterize motion of the plurality of vehicles (e.g., vehicles 100 and 200) in at least one specific driving situation (e.g., driving situation 300).

In some embodiments, server computing device 40 may further include driving situation analysis module 42. Driving situation analysis module 42 may be configured to receive motion data elements 41A. Driving situation analysis module 42 may be further configured to analyze the plurality of motion data elements 41A, to determine sequences of motion data elements 41A (e.g., sequences 311-315 and 321-326, as shown in FIG. 2), representing the plurality of motion scenarios 42A″ (e.g., motion scenarios 310 and 320, as shown in FIG. 2).

Driving situation analysis module 42 may be further configured to form a plurality of decision data elements 42A′, respectively representing plurality of expected driver decisions (e.g., driver decisions 10A′ and 10A″) each corresponding to following a particular motion scenario of the plurality of motion scenarios 42A″ (e.g., motion scenarios 310 and 320, as shown in FIG. 2).

In some embodiments, server computing device 40 may further include training module 44. Training module 44 may be configured to construct behavioral model 44′ representing expected driver behavior in the at least one specific driving situation (e.g., driving situation 300), based on the plurality of motion data elements 41A. In some embodiments, behavioral model 44′ may be a machine-learning (ML)-based model. Thus, in some embodiments, training module 44 may be further configured to construct behavioral model 44′ by training behavioral model 44′ based on the plurality of decision data elements 42A′ to: (a) receive the incoming motion data element (e.g., motion data elements 31A or 41A); (b) calculate probabilities of occurrence of particular driver decisions of the plurality of expected driver decisions (e.g., decisions 10A′ and 10A″), based on incoming motion data element (e.g., motion data elements 31A or 41A), and (c) predict occurrence of the particular driver decision, based on the calculated probabilities.

It shall be understood that ML-based model may be based on any known machine learning and artificial intelligence techniques (e.g., Artificial Neural Networks, Linear Regression, Decision Tree Regression, Random Forest, KNN Model, Support Vector Machines (SVM)) (or combination thereof) commonly utilized for classification, clustering, regression and other tasks, that may be relevant to purposes of the present invention. Consequently, the scope of the invention is not limited to any specific embodiments of ML-based model, and it is implied herein that it will be clear for the person skilled in the art which techniques to apply in order to train the ML-based model for predicting the expected driver behavior (e.g., driver decisions 10A′ or 10A″) in the form of outcoming motion data elements 10A.

In some embodiments, server computing device 40 may further include segmenting module 45. Segmenting module 45 may be configured to receive geolocation data elements 21A′″ of the plurality of vehicles (e.g., vehicles 100 and 200) and to segment behavioral model 44′ in order to obtain segment 45′ of behavioral model 44′, representing a geographic region that surrounds geolocation 21A″ of respective vehicle (e.g., vehicle 100 and 200). Server computing device 40 may be further configured to transmit segments 45′ to client computing devices 30 of respective vehicles (e.g., vehicles 100 and 200).

In some embodiments, server computing device 40 may further include vehicle profile analysis module 43. Vehicle profile analysis module 43 may be configured to analyze the plurality of decision data elements 42A′ to obtain baseline profile data element 43A′, representing a baseline distribution of the plurality of expected driver decisions (e.g., driver decisions 10A′ and 10A″) with respect to particular motion scenarios 42A″ of the plurality of motion scenarios 42A″.

In some embodiments, vehicle profile analysis module 43 may be further configured to analyze incoming motion data elements (e.g., motion data elements 41A) of the specific vehicle (e.g., vehicle 100 or 200), in relation to baseline profile data element 43A′, to obtain vehicle-specific profile data element 43A″, representing deviation of one or more driver decisions (e.g., decisions 10A′ and 10A″) of the respective vehicle (e.g., vehicle 100 or 200), with respect to following the at least one particular motion scenario (e.g., motion scenarios 310 or 320, shown in FIGS. 3A and 3B). Reference is now made back to FIG. 4A.

In some embodiments, client computing device 30 may be configured to receive respective vehicle-specific profile data element 43A″ of either the vehicle associated with device 30 (e.g., vehicle 100) or of another vehicle (e.g., vehicle 200).

Client computing device 30 may be further configured to infer behavioral model 44′, in particular, segment 45′ of behavioral model 44′, on (a) incoming motion data elements 31A or 41A respectively, and (b) vehicle-specific profile data element 43A″ of respective vehicle (e.g., of the same vehicle, e.g. first vehicle 100, or another vehicle, e.g., second vehicle 200) to predict occurrence of particular driver decision of the plurality of expected driver decisions (e.g., driver decisions 10A′ and 10A″).

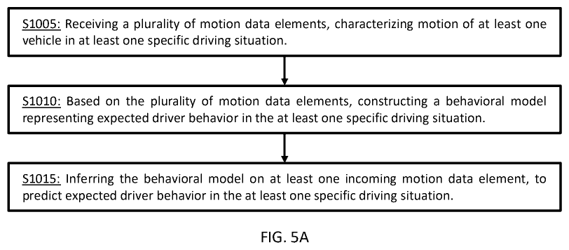

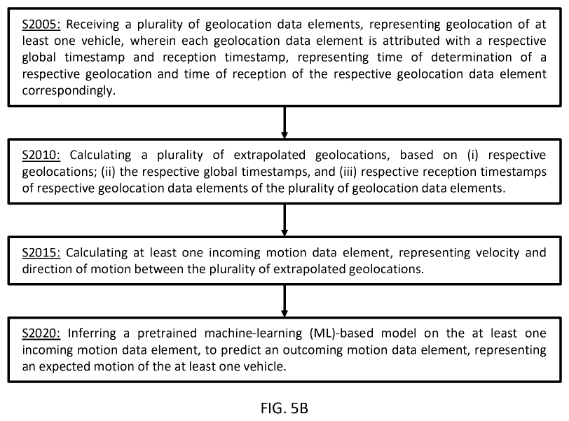

Referring now to FIG. 5A, a flow diagram is presented, depicting a method of predicting driver behavior, by at least one processor, according to some embodiments.

As shown in step S1005, the at least one processor (e.g., processor 2 of FIG. 1) may perform reception of a plurality of motion data elements (e.g., motion data elements 31A or 41A), characterizing motion of at least one vehicle (e.g., vehicle 100 or 200) in at least one specific driving situation (e.g., driving situation 300). Step S1005 may be carried out by motion data element generating module 31 (as described with reference to FIGS. 4A-4C) As shown in step S1010, the at least one processor (e.g., processor 2 of FIG. 1) may perform construction, based on the plurality of motion data elements (e.g., motion data elements 31A or 41A), of a behavioral model (e.g., behavioral model 44′) representing expected driver behavior (e.g., driver decisions 10A′ or 10A″) in the at least one specific driving situation (e.g., driving situation 300). Step S1010 may be carried out by driving situation analysis module 42 and training module 44 (as described with reference to FIG. 4° C.).

As shown in step S1015, the at least one processor (e.g., processor 2 of FIG. 1) may perform inference of the behavioral model (e.g., behavioral model 44′) on at least one incoming motion data element (e.g., motion data elements 31A or 41A), to predict expected driver behavior (e.g., driver decisions 10A′ or 10A″) in the specific driving situation (e.g., driving situation 300). Step S1015 may be carried out by client computing device 30 (as described with reference to FIGS. 4A and 4B).

Referring now to FIG. 5B, a flow diagram is presented, depicting a method of predicting motion of a vehicle, by at least one processor, according to some embodiments.

As shown in step S2005, the at least one processor (e.g., processor 2 of FIG. 1) may perform reception of a plurality of geolocation data elements (e.g., geolocation data elements 21A″), representing geolocation (e.g., geolocation 21A″) of at least one vehicle (e.g., vehicles 100 and 200), wherein each geolocation data element (e.g., geolocation data elements 21A″) is attributed with a respective global timestamp (e.g., global timestamp 24A′ or 24A) and reception timestamp (e.g., reception timestamp 24A″), representing time of determination of a respective geolocation (e.g., geolocation 21A″) and time of reception of the respective geolocation data element (e.g., geolocation data element 21A″) correspondingly. Step S2005 may be carried out by motion data element generating module 31 (as described with reference to FIGS. 4B-4C).

As shown in step S2010, the at least one processor (e.g., processor 2 of FIG. 1) may perform calculation of a plurality of extrapolated geolocations (e.g., extrapolated geolocations 21B″), based on (i) respective geolocations (e.g., geolocation 21A″); (ii) the respective global timestamps (e.g., global timestamp 24A′), and (iii) respective reception timestamps (e.g., reception timestamp 24A″) of respective geolocation data elements of the plurality of geolocation data elements (e.g., geolocation data elements 21A′″). Step S2010 may be carried out by motion data element generating module 31 (as described with reference to FIG. 4B).

As shown in step S2015, the at least one processor (e.g., processor 2 of FIG. 1) may perform calculation of at least one incoming motion data element (e.g., incoming motion data element 31A), representing velocity and direction of motion between the plurality of extrapolated geolocations (e.g., extrapolated geolocations 21B″). Step S2015 may be carried out by motion data element generating module 31 (as described with reference to FIG. 4B).

As shown in step S2020, the at least one processor (e.g., processor 2 of FIG. 1) may perform inference of a pretrained machine-learning (ML)-based model (e.g., behavioral model 44′ or segment 45′ of behavioral model 44′) on the at least one incoming motion data element (e.g., incoming motion data element 31A), to predict an outcoming motion data element (e.g., outcoming motion data element 10A), representing an expected motion of the at least one vehicle (e.g., vehicle 100 or 200). Step S2020 may be carried out by client computing device 30 (as described with reference to FIG. 4B).

As can be seen from the provided description, the claimed invention represents the system and method of predicting driver behavior which provide an improvement of the technological field of advanced driver assistance and autonomous driving by reducing risk of collisions occurring due to human error.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of predicting driver behavior by at least one computing device, the method comprising
receiving a plurality of motion data elements, characterizing motion of at least one vehicle in at least one specific driving situation;
based on the plurality of motion data elements, constructing a behavioral model representing expected driver behavior in the at least one specific driving situation;
inferring the behavioral model on at least one incoming motion data element, to predict expected driver behavior in the at least one specific driving situation.

2. The method of claim 1, wherein the at least one specific driving situation is predefined by a plurality of motion scenarios;
wherein the expected driver behavior is predefined by a plurality of expected driver decisions each corresponding to following a particular motion scenario of the plurality of motion scenarios;
and wherein inferring the behavioral model comprises inferring the behavioral model on the at least one incoming motion data element, to predict occurrence of a particular driver decision of the plurality of expected driver decisions.

3. The method of claim 2, wherein each of the plurality of motion scenarios is represented as a sequence of respective motion data elements of the plurality of motion data elements.

4. The method of claim 1, wherein
the behavioral model is a machine-learning (ML)-based model; and wherein constructing the behavioral model comprises:
analyzing the plurality of motion data elements, to determine sequences of motion data elements of the plurality of motion data elements, representing the plurality of motion scenarios;
forming a plurality of decision data elements, respectively representing plurality of expected driver decisions each corresponding to following a particular motion scenario of the plurality of motion scenarios;
training the behavioral model based on the plurality of decision data elements to: (a) receive the incoming motion data element; (b) calculate probabilities of occurrence of particular driver decisions of the plurality of expected driver decisions, based on the incoming motion data element, and (c) predict occurrence of the particular driver decision, based on said probabilities.

5. The method of claim 4,
wherein receiving the plurality of motion data elements comprises receiving a plurality of motion data elements, characterizing motion of a plurality of vehicles in the at least one specific driving situation; and wherein the method further comprises:
analyzing the plurality of decision data elements to obtain a baseline profile data element, representing a baseline distribution of the plurality of expected driver decisions with respect to the at least one particular motion scenario of the plurality of motion scenarios; and
analyzing at least one incoming motion data element of the at least one vehicle, in relation to the baseline distribution, to obtain a vehicle-specific profile data element, representing deviation of one or more driver decisions of the respective vehicle, with respect to following the at least one particular motion scenario.

6. The method of claim 5, wherein the method further comprises:
receiving the vehicle-specific profile data element of the at least one vehicle;
and wherein inferring the behavioral model further comprises inferring the behavioral model on (a) the at least one incoming motion data element, and (b) the vehicle-specific profile data element, to predict occurrence of the particular driver decision of the plurality of expected driver decisions.

7. (canceled)

8. The method of claim 1, wherein said constructing of the behavioral model is performed by at least one server computing device, and wherein said inferring of the behavioral model is performed by at least one client computing device, communicatively connected to the at least one server computing device.

9. The method of claim 8, wherein the at least one client computing device is associated with a first vehicle, and wherein the method further comprises:
determining, by the at least one client computing device, the geolocation of the first vehicle;
obtaining, by the at least one client computing device from the at least one server computing device, a segment of the behavioral model, representing a geographic region that surrounds the geolocation of the first vehicle;
obtaining, by the at least one client computing device from the at least one server computing device, at least one second motion data element corresponding to geolocation of a second vehicle within the geographic region;
inferring, by the at least one client computing device, the segment of the behavioral model on the at least one second motion data element, to predict occurrence of the particular driver decision of the second vehicle.

10. The method of claim 8, wherein
the particular driver decision of the second vehicle is represented by at least one second outcoming motion data element, characterizing an expected motion of the second vehicle in the at least one specific driving situation within the geographic region; and
wherein the method further comprises calculating an expected motion trajectory of the second vehicle, based on the at least one second outcoming motion data element of the second vehicle.

11. The method of claim 9, further comprising:
receiving, by the at least one client computing device, the at least one first incoming motion data element, characterizing current motion of the first vehicle;
inferring, by the at least one client computing device, the segment of the behavioral model on the at least one first incoming motion data element, to predict occurrence of the particular driver decision of the first vehicle, represented by at least one first outcoming motion data element, characterizing an expected motion of the first vehicle in the at least one specific driving situation within the geographic region;
calculating, by the at least one client computing device, an expected motion trajectory of the first vehicle, based on the at least one first outcoming motion data element;
calculating, by the at least one client computing device, a risk of collision between the first vehicle and the second vehicle, based on the expected motion trajectories of the first vehicle and the second vehicle; and
when the calculated risk of collision surpasses a predefined threshold, then providing a collision warning via a user interface (UI) of the client computing device.

12. The method of claim 10, wherein calculating the expected motion trajectory comprises iteratively inferring, by the at least one client computing device, the segment of the behavioral model on at least one respective outcoming motion data element calculated on a preceding iteration, to predict a sequence of respective driver decisions of the respective vehicle, represented as a sequence of outcoming motion data elements, wherein outcoming motion data element of each iteration represents motion of the respective vehicle at a future point in time that precedes that of a subsequent iteration.

13. The method of claim 11, wherein
the sequence of respective driver decisions is associated with a probability of occurrence of each of the respective driver decisions; and
wherein calculating the expected motion trajectory further comprises calculating a diminishing probability path data element, representing probability of following the expected motion trajectory, based on (i) the sequence of outcoming motion data elements, and (ii) the respective probabilities of occurrence of the respective driver decisions.

14. (canceled)

15. The method of claim 1, wherein each of the plurality of motion data elements represents at least one of (a) a geolocation of the at least one vehicle; (b) a velocity of the at least one vehicle; (c) an acceleration of the at least one vehicle; (d) a motion direction of the at least one vehicle.

16. (canceled)

17. The method of claim 1, further comprising
receiving a plurality of geolocation data elements, representing respective plurality of geolocations of the at least one vehicle, wherein the plurality of geolocation data elements is attributed with respective global timestamps and reception timestamps, representing time of determination of a respective geolocation and time of reception of the respective geolocation data element correspondingly;
calculating extrapolated geolocations of the at least one vehicle, based on (i) the respective plurality of geolocations; (ii) respective global timestamps and (iii) respective reception timestamps of the plurality geolocation data elements; and
calculating the at least one incoming motion data element as a motion vector, further based on the extrapolated geolocations.

18. A method of predicting motion of a vehicle by at least one computing device, the method comprising
receiving a plurality of geolocation data elements, representing geolocation of at least one vehicle, wherein each geolocation data element is attributed with a respective global timestamp and reception timestamp, representing time of determination of a respective geolocation and time of reception of the respective geolocation data element correspondingly;
calculating a plurality of extrapolated geolocations, based on (i) respective geolocations; (ii) the respective global timestamps, and (iii) respective reception timestamps of respective geolocation data elements of the plurality of geolocation data elements,
calculating at least one incoming motion data element, representing velocity and direction of motion between the plurality of extrapolated geolocations;
inferring a pretrained machine-learning (ML)-based model on the at least one incoming motion data element, to predict an outcoming motion data element, representing an expected motion of the at least one vehicle.

19. The method of claim 15, further comprising
receiving a plurality of geolocation data elements, representing geolocation of a plurality of vehicles;
based on the plurality of geolocation data elements, calculating a plurality of motion data elements, representing velocity and direction of motion of respective vehicles of the plurality of vehicles between respective geolocations;
analyzing the plurality of motion data elements, to determine sequences of motion data elements of the plurality of motion data elements, representing a plurality of motion scenarios in at least one specific driving situation;
forming a plurality of decision data elements, respectively representing plurality of expected driver decisions each corresponding to following a particular motion scenario of the plurality of motion scenarios;
training the ML-based model based on the plurality of decision data elements to: (a) receive the incoming motion data element; (b) calculate a probability of occurrence of each of the plurality of expected driver decisions, (c) predict occurrence of a particular driver decision of the plurality of expected driver decisions, based on the calculated probabilities, (d) calculate the outcoming motion data element, characterizing an expected motion of the at least one vehicle in the at least one specific driving situation, based on the predicted occurrence of the particular driver decision.

20. A system for predicting driver behavior, the system comprising: a non-transitory memory device, wherein modules of instruction code are stored, and at least one processor associated with the memory device, and configured to execute the modules of instruction code, whereupon execution of said modules of instruction code, the at least one processor is configured to:
receive a plurality of motion data elements, characterizing motion of at least one vehicle in at least one specific driving situation;
based on the plurality of motion data elements, construct a behavioral model representing expected driver behavior in the at least one specific driving situation;
infer the behavioral model on at least one incoming motion data element, to predict expected driver behavior in the at least one specific driving situation.

21. The system of claim 17, wherein the at least one specific driving situation is predefined by a plurality of motion scenarios;
wherein the expected driver behavior is predefined by a plurality of expected driver decisions each corresponding to following a particular motion scenario of the plurality of motion scenarios;
and wherein the at least one processor is configured to infer the behavioral model further by inferring the behavioral model on the at least one incoming motion data element, to predict occurrence of a particular driver decision of the plurality of expected driver decisions.

22. The system of claim 18, wherein each of the plurality of motion scenarios is represented as a sequence of respective motion data elements of the plurality of motion data elements.

23. The system of claim 18, wherein
the behavioral model is a machine-learning (ML)-based model; and wherein the at least one processor is configured to construct the behavioral model by:
analyzing the plurality of motion data elements, to determine sequences of motion data elements of the plurality of motion data elements, representing the plurality of motion scenarios;
forming a plurality of decision data elements, respectively representing plurality of expected driver decisions each corresponding to following a particular motion scenario of the plurality of motion scenarios;
training the behavioral model based on the plurality of decision data elements to: (a) receive the incoming motion data element; (b) calculate probabilities of occurrence of particular driver decisions of the plurality of expected driver decisions, based on the incoming motion data element, and (c) predict occurrence of the particular driver decision, based on said probabilities.

24-36. (canceled)
